(19) United States
(12) Patent Application Publication
(10) Pub. No.: US 2011/0187756 A1
(43) Pub. Date: Aug. 4, 2011

(54) DRIVE CONTROL APPARATUS AND DRIVE CONTROL METHOD FOR ELECTROPHORETIC DISPLAY UNIT, ELECTROPHORETIC DISPLAY DEVICE, AND ELECTRONIC APPARATUS

(75) Inventor: Takuya ONO, Chino (JP)

(73) Assignee: SEIKO EPSON CORPORATION, Tokyo (JP)

(21) Appl. No.: 13/009,897

(22) Filed: Jan. 20, 2011

(30) Foreign Application Priority Data
Feb. 4, 2010 (JP) 2010-023127

(51) Int. Cl. G09G 3/34; G09G 5/10

(52) U.S. Cl. 345/690; 345/107

(57) ABSTRACT

Provided is a drive control apparatus for an electrophoretic display unit which performs drive control on the electrophoretic display unit. If a writing request of a new display image to be displayed on the electrophoretic display unit is detected, before a voltage of a pixel electrode for each pixel, and a common electrode is controlled to have a voltage corresponding to the new display image, a display change preprocessing portion controls the pixel electrode and the common electrode for the pixel displaying the black color to have an equal potential.

### BACKGROUND

1. Technical Field

The present invention relates to a drive control technology for an image display using an electrophoretic element storing electrophoretic particles therein, an electrophoretic display device and an electronic apparatus using the technology.

2. Related Art

Recently, much effort has been put into the development of electrophoretic display devices. A plurality of pixels is arranged in a matrix pattern on an electrophoretic display unit of the electrophoretic display device. Each of the pixels has a pixel electrode and a common electrode which are opposed to each other with an electrophoretic element interposed therebetween. The voltage of the pixel electrode of the respective pixels and the common electrode is controlled to cause the electrophoretic particles of the electrophoretic element to move, thereby controlling the image display. In the electrophoretic element for displaying the image, a gradation is retained even after the application of the voltage is cut off. That is, in the electrophoretic display unit of the electrophoretic display device, the current image display is retained even after the application of the voltage is cut off. For this reason, for the purpose of obtaining a good image display, before the display image is changed, a reset processing of erasing the current display image is generally carried out. For example, the reset processing is carried out by controlling the voltage of all the pixels so as to make the gradation of all the pixels constituting the electrophoretic display unit white.

However, as described above, there is a case where if the gradation of each pixel is controlled so as to make the whole screen white when the image display is erased, a portion displaying black becomes gray at the time of writing the next display image, so that a good display (contrast) cannot be obtained. The reason is as follows. That is, if the gradation of the pixel is controlled to be white so as to carry out the reset processing, the black electrophoretic particles including charged particles move to a bottom side opposite to a displaying surface side, and come in contact with a wall surface of the bottom side of a microcapsule in the electrophoretic display device, thereby entering the adhered state. In the pixel which becomes the black gradation at the process of writing the next new display image, it causes the movement of the black electrophoretic particles to the displaying surface side to slow down. That is, at the time of processing the next image display, the white electrophoretic particles collide against the black electrophoretic particles, and thus it takes time to shift the black electrophoretic particles. Otherwise, since a part of the black electrophoretic particles does not completely move to the displaying surface side, it results in an adverse effect on the contrast of the gradation.

As a measure against this problem, an example of a related art is disclosed in JP-A-2008-139739. In the related art, before the writing of a new display image is carried out, a pulse voltage of a predetermined frequency is applied to at least one of the pixel electrodes and the common electrode. Ions are detached from the black electrophoretic particles, which are the charged particles, by application of the pulse voltage, thereby increasing an electrophoretic velocity of the black electrophoretic particles.

However, the application of the pulse voltage as the reset processing causes the power consumption to increase. For this reason, in a case where a power source is a battery, it causes a shortening of the usable time of the battery. In addition, due to the application of the pulse voltage, the screen display blinks on and off before the new display image is displayed. This causes visual quality of an image viewed by a user to be deteriorated.

### SUMMARY

An advantage of some aspects of the invention is to obtain a good display image at the time of changing a display image while suppressing an increase in power consumption.

According to a first aspect of the invention, there is provided a drive control apparatus for an electrophoretic display unit performing drive control on the electrophoretic display unit which includes a plurality of pixels which are configured by placing electrophoretic elements storing electrophoretic particles between pixel electrodes and a common electrode opposite to the pixel electrodes and which displays an image by determining a gradation to be displayed at each of the plurality of pixels in accordance with a voltage applied to the pixel electrode and the common electrode, the drive control apparatus including a display change preprocessing portion that, if a writing request of the display image to be displayed on the electrophoretic display unit is detected, controls the pixel electrodes and the common electrode for at least a part of the plurality of pixels to have an equal potential before the voltage of the pixel electrodes and the common electrode for each of the plurality of pixels, and the common electrode is controlled to have a voltage corresponding to display image having a writing request.

The equal potential may be applied only for a predetermined reset period. The reset period can be set to, for example, a time necessary for writing the image, or a time necessary to space and disperse electrophoretic particles, which come in contact with a wall surface of a storage container (microcapsule or the like) storing the electrophoretic particles, from the contacting wall surface to a certain extent in an experiment or the like.

Before the display image having a writing request is displayed, the pixel electrodes and the common electrode in at least some pixels are set to have the equal potential. In this way, even though the first electrophoretic particles charged with a first polarity are aggregated at one electrode side in the current display image, the pixels set to have the equal potential are in the state where the electrophoretic particles aggregated at the one electrode side are spaced apart from the wall surface of the one electrode side of the wall surfaces of the storage container, and thus are floated. That is, in the inside of the storage container for the electrophoretic element, the electrophoretic particles aggregated at the one electrode side are dispersed to some extent. For this reason, when the voltage of the pixel electrode and the common electrode of the pixel is set to have a voltage corresponding to the display image having a writing request, the movement of the electrophoretic particles to the displaying surface side can be fast. In this way, when the writing of the display image having a writing request is carried out, it is possible to obtain a good display, causing an improvement in contrast.

In this instance, since the equal potential is simply set as the display change preprocessing portion, an increase in the power consumption is suppressed. In addition, since the electrophoretic particles are simply set to have the equal potential and dispersed to some extent, when the display is shifted to the display image having a writing request is shifted from the current display image, screen blinking is not easily generated. It is possible to obtain a better display image at the time of changing the display image, for example, which reduces the stress on the eyes of a user.

It is preferable that the plurality of pixels have at least a first gradation as each display, and the display change preprocessing portion controls the pixel electrode and the common electrode of the pixel, which becomes the first gradation, to have an equal potential in the display image having a writing request.

The pixel electrode and the common electrode of the pixel, which becomes the first gradation, are controlled to have an equal potential in the display image having a writing request. In this way, even though the electrophoretic particles corresponding to the first gradation in the current display image are aggregated at the bottom side opposite to the displaying surface side of the storage container, the electrophoretic particles corresponding to the first gradation are spaced apart from the bottom surface, and thus are dispersed. For this reason, when the voltage is applied to the pixel electrode and the common electrode of the pixel so as to display the display image having a writing request, the electrophoretic particles corresponding to the first gradation move fast to the displaying surface side. As a result, it is possible to more reliably display the first gradation aimed for.

In addition, it is preferable that each of the plurality of pixels has at least a first gradation, and first electrophoretic particles for displaying the first gradation are negatively or positively charged. The display change preprocessing portion controls first pixel electrode and the common electrode of the first pixel, which becomes the first gradation, in the display image having a writing request, among each of the plurality of pixels, to have the equal potential, and controls a second pixel electrode and the common electrode of a second pixel, which becomes a second gradation different from the first gradation, in the display image having a writing request, to have a voltage corresponding to the gradation displayed on the display image having a writing request.

Before the writing processing of the display image which is required to write is carried out, the display image having a writing request is adjusted in such a way that the electrophoretic particles of the first pixel, which becomes the first gradation, are dispersed, and the electrophoretic particles of the second pixel, which becomes the second gradation different from the first gradation, become the gradation to be displayed on the display image having a writing request in advance. As a result, when the writing processing is carried out on the display image having a writing request, the first pixel, which becomes the first gradation, in the display image having a writing request can become the first gradation more reliably, and the second pixel can become the target gradation more reliably. Consequently, the contrast of the display image having a writing request is improved.

Further, it is preferable that the voltage of the pixel electrode and the common electrode in each of the plurality of pixels is respectively controlled to have any one of two kinds of the predetermined voltage values to control each display of the plurality of pixels with the gradation according to the image to be displayed. The display change preprocessing portion sets the voltage of the plurality of pixel electrodes and the voltage of the common electrode to any one of two kinds of the voltage values, to control the pixel electrode and the common electrode to have the equal potential.

The voltage of the plurality of pixel electrodes and the voltage of the common electrode are set to any one of two kinds of the voltage values to control the pixel electrodes and the common electrode to have the equal potential. Consequently, since the drive control is carried out by two-value control, the drive control including the display change preprocessing portion is easily carried out.

In addition, it is preferable that the voltage of the pixel electrode of each pixel is set to any one of two kinds of the predetermined voltage values, and the voltage of the common electrode is set to have an intermediate potential which is a voltage value between two kinds of the voltage values, thereby controlling each display of the plurality of pixels with the gradation according to the image to be displayed. The display change preprocessing portion sets the voltage of the pixel electrodes and the common electrode to an intermediate potential to control the pixel electrode and the common electrode to have the equal potential.

Therefore, at the time of writing the display image having a writing request, the gradation display of the pixel which is set to have the equal potential by the display change preprocessing portion is improved.

Further, according to a second aspect of the invention, there is provided an electrophoretic display device including the above-described electrophoretic display unit, and a drive control device for the electrophoretic display unit.

According to the aspect, it is possible to provide the electrophoretic display device capable of carrying out good gradation display.

In addition, according to a third aspect of the invention, there is provided an electronic apparatus including the above-described electrophoretic display device.

According to the aspect, it is possible to provide the electronic apparatus capable of carrying out good gradation display.

Herein, the electrophoretic display device according to the aspect can be applied in such a way that it is mounted on the electronic apparatus including the electrophoretic display unit or the like. For example, it can be applied to the electronic apparatuses including display devices, televisions, electronic books, electronic papers, watches, electronic calculators, mobile phones, and portable information terminals. The electrophoretic display device according to the aspect may also be applied to other objects that do not belong to the concept of “device”, such as flexible paper/film-like objects, immovable objects such as walls that can be used to fix these objects, or movable objects such as vehicles, air vehicles, and ships.

Further, according to a fourth aspect of the invention, there is provided a drive control method for an electrophoretic display unit which includes a plurality of pixels configured by placing electrophoretic elements having a storage container storing first electrophoretic particles corresponding to at least a first gradation and including charged particles, between pixel electrodes and a common electrode opposite to the pixel electrodes, and which displays an image by determining each gradation of the plurality of pixels in accordance with a voltage applied to the pixel electrodes and the common electrode. In this method, if a writing request of the display image to be displayed on the electrophoretic display unit is detected, before controlling the voltage of the plurality of the pixel electrodes and the common electrode for the plurality of pixels is controlled to have a voltage corresponding to the display image having a writing request, in each of the plurality of pixels, a potential difference between the common electrode and the pixel electrodes which become the first gradation in the display image having a writing request is set to a potential difference, which can float the first electrophoretic particles including the charged particles away from a wall surface of the storage container of the electrophoretic element, during a predetermined reset period.

The reset period may be differently set in accordance with the “potential difference which can float the electrophoretic particles.”

The potential difference is set to, for example, zero (equal potential) or a value (for example, the potential difference of 2V or less) nearly close to zero. Alternatively, the potential difference is a value smaller than a potential difference when the first gradation and the second gradation are displayed, and may be set to a small potential difference value which can space (float) the first electrophoretic particles including the charged particles away from the state of coming in contact with the wall surface of the storage container of the one electrode side in the electrophoretic element. In this instance, the floating is in the state where “the first electrophoretic particles including the charged particles are spaced apart from the pixel electrode and the common electrode.”

Even in the state where the first electrophoretic particles are aggregated at the one electrode side in the current display image, as the potential difference is set to a potential difference, which can float the first electrophoretic particles away from the wall surface of the storage container of the electrophoretic element, the first electrophoretic particles are in the state where the particles are spaced (floated) apart from the wall surface of the storage container of the one electrode side. Herein, since the potential difference is not generated until the first electrophoretic particles are attracted to the other electrode side, the first electrophoretic particles are spaced apart from both electrodes. That is, the first electrophoretic particles are dispersed to some extent in the inside of the electrophoretic element. For this reason, when the display image having a writing request is carried out, it is possible to make the response of the first electrophoretic particles fast. In this way, it is possible to obtain the first gradation display which is excellent in the display image having a writing request.

### BRIEF DESCRIPTION OF THE DRAWINGS

The invention will be described with reference to the accompanying drawings, wherein like numbers reference like elements.

FIG. 1 is a view illustrating an overall electrical configuration of an electrophoretic display device according to a first embodiment of the invention.

FIG. 2 is a view illustrating a configuration of a pixel according to the first embodiment of the invention.

FIG. 3 is a view illustrating a configuration of a display controller according to the first embodiment of the invention.

FIGS. 4A and 4B are a view illustrating a processing of a display controller according to the first embodiment of the invention.

FIG. 5 is a view illustrating an example of a timing chart of each voltage according to the first embodiment of the invention.

FIGS. 6A to 6C are views illustrating an example of a display change according to the first embodiment of the invention.

FIGS. 7A to 7C are views illustrating an operation according to the first embodiment of the invention.

FIG. 8 is a view illustrating a change of a voltage according to the first embodiment of the invention.

FIGS. 9A to 9D are views illustrating a problem of a comparative example.

FIGS. 10A to 10C are views illustrating examples of an electronic apparatus.

FIG. 11 is a view illustrating an example of a timing chart of each voltage according to a second embodiment of the invention.

FIGS. 12A and 12B are views illustrating an operation according to a related art.

FIGS. 13A to 13C are views illustrating an operation according to a second embodiment of the invention.

### DESCRIPTION OF EXEMPLARY EMBODIMENTS

Embodiments of the invention will now be described with reference to the accompanying drawings.

In the below description, a first gradation to be displayed is set to black color, and a second gradation to be displayed is set to white color. A case where an image is displayed on an electrophoretic display unit by using the white and the black is described as an example. Herein, the first gradation to be displayed and the second gradation to be displayed do not have to be a set of white and black colors, and other colors are possible. That is, the invention can be applied to a color image display. For example, the first gradation can be set as red, and the second gradation can be set as black.

### First Embodiment

### Configuration

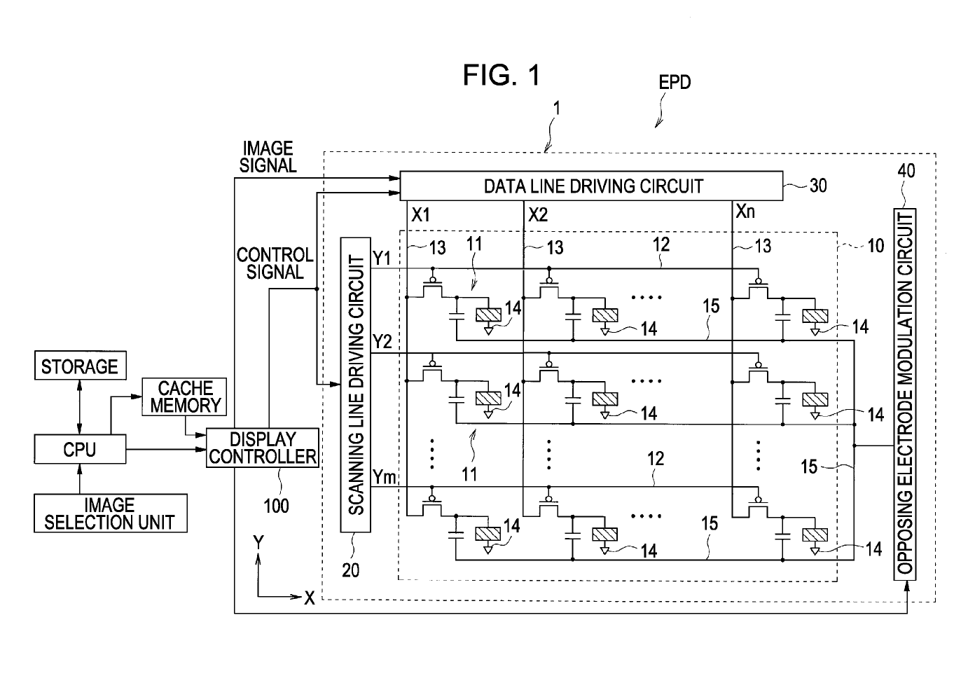

FIG. 1 is a conceptual diagram illustrating an electrical configuration of an electrophoretic display device EPD according to an embodiment of the invention.

The electrophoretic display device EPD according to the embodiment of the invention includes an electrophoretic display unit 1 and a display controller 100. The display controller 100 controls the display of the electrophoretic display unit 1. The display controller 100 constitutes a drive control apparatus for the electrophoretic display unit.

The electrophoretic display unit 1 includes an electrophoretic display panel 10, a scanning line driving circuit 20, a data line driving circuit 30, and an opposing electrode modulation circuit 40.

The electrophoretic display panel 10 includes a plurality of pixels 11, scanning lines 12, data lines 13, and a holding capacitor line 15.

That is, the plurality of scanning lines 12 are arranged in a longitudinal direction (Y direction) in FIG. 1 in the electrophoretic display panel 10. The plurality of data lines 13 are arranged in parallel with a direction (X direction) interecting the scanning lines 12. FIG. 1 illustrates a case where the scanning lines 12 and the data lines 13 are perpendicular to each other. In addition, each pixel 11 is arranged in a matrix pattern at a position corresponding to intersection between the scanning line 12 and the data line 13. Further, a plurality of holding capacitor lines 15 are placed in the same direction as the scanning line 12.

In addition, the scanning line driving circuit 20 supplies a voltage signal to the scanning line 12 in accordance with a control signal from the display controller 100. The data line driving circuit 30 supplies a voltage signal to the data line 13 in accordance with a control signal from the display controller 100. The opposing electrode modulation circuit 40 supplies a voltage signal to a common electrode line 14 in accordance with a control signal from the display controller 100.

A configuration example of each pixel 11 will now be described.

Each pixel 11 is formed by placing an electrophoretic element storing at least two kinds of electrophoretic particles between the pixel electrode and the common electrode which are opposed to each other. In each pixel 11, as the electrophoretic particles move in accordance with a voltage applied to the pixel electrode and the common electrodes, each pixel 11 displays the target gradation.

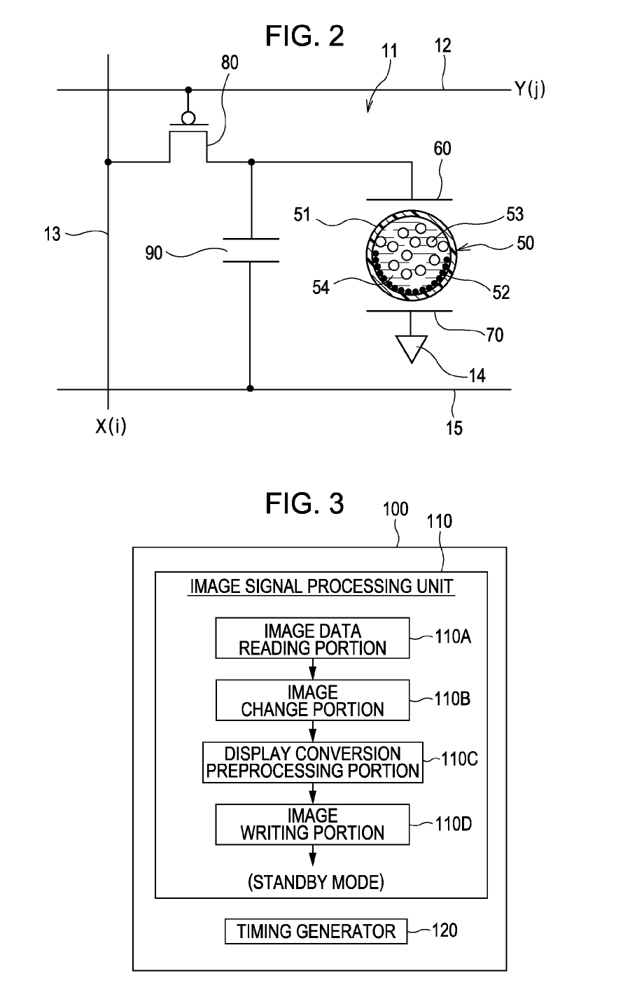

The pixel 11 is formed by the configuration, for example, shown in FIG. 2.

The pixel 11 shown in FIG. 2 includes an electrophoretic element 50, a TFT 80 serving as a switching element, a pixel electrode 60, a common electrode 70, and a holding capacitor 90. The electrophoretic element 50 is placed between the pixel electrode 60 and common electrode 70 which are correspondingly placed as described above. In this instance, the common electrode 70 is an electrode for applying a common potential to the plurality of pixels 11, and may be physically segmented for each pixel 11. The TFT 80 is, for example, a p-type organic transistor. In this instance, the TFT 80 has a gate terminal connected to the scanning line 12, and a source terminal connected to the data line 13. In addition, a drain terminal of the TFT 80 is connected to the pixel electrode 60 and the holding capacitor 90. The holding capacitor 90 holds the voltage applied to the pixel electrode 60 by the TFT 80.

The pixel 11 is formed by placing the electrophoretic element 50 between the pixel electrode 60 and the common electrode 70. For this reason, the pixel 11 forms a pixel capacitance in accordance with an electrode area, a distance between the electrodes, and a dielectric constant of the electrophoretic element 50. The common electrode 70 is connected to the opposing electrode modulation circuit 40 via the common electrode line 14. In addition, the other side of the holding capacitor 90 is connected to the holding capacitor line 15. The holding capacitor lines 15 are connected to a power source via the opposing electrode modulation circuit 40.

The electrophoretic element 50 includes, as shown in FIG. 2, a storage container 51 of a microcapsule type or a partition type (not illustrated), of which at least a displaying surface side is transparent to a visible light, a dispersion medium 54 which is sealed in the storage container 51 and includes a liquid which is transparent to the visible light, and two kinds of electrophoretic particles 52 and 53 which are dispersed in the dispersion medium 54 or come in contact with an inner wall of the storage container 51.

Herein, the case where the storage container 51 is constituted of the microcapsule will be described. The microcapsule has, for example, a grain size of about 50 μm, and is formed of acrylic resin such as poly methyl methacrylate and poly ethyl methacrylate, polymeric resin capable of transmitting a visible light, such as urea resin, Arabic gum, or the like. In addition, one or a plurality of microcapsules is arranged in a matrix in a plane within one pixel 11. Further, in order to bury the circumference of the microcapsule, a binder (not illustrated) for fixing the microcapsule is provided.

Examples of the dispersion medium 54 includes water, alcoholic solvent (such as methanol, ethanol, isopropanol, butanol, octanol, and methyl cellosolve), various esters (such as ethyl acetate and butyl acetate), ketones (such as acetone, methylethyl ketone, and methyl isobutyl ketone), aliphatic hydrocarbons (such as pentane, hexane, and octane), alicyclic hydrocarbons (such as cyclohexane and methyl cyclohexane), aromatic hydrocarbons (such as benzene, toluene, and benzenes having a long-chain alkyl group (such as benzene, toluene, xylene, hexyl benzene, heptyl benzene, octyl benzene, nonyl benzene, decyl benzene, undecyl benzene, dodecyl benzene, tridecyl benzene, and tetradecyl benzene)), halogenated hydrocarbon (such as methylene chloride, chloroform, carbon tetrachloride, and 30-dichloroethane), carboxylate salt, and other oil substances, in which these materials may be used alone or as a mixture thereof with surfactant.

In addition, two kinds of the electrophoretic particles 52 and 53 contained in the storage container 51 are constituted of black particles 52 and white particles 53 in this embodiment. The black particles 52 and the white particles 53 are particles (polymer or colloid) having a property of being moved in the dispersion medium 54 by an electric field.

The black particles 52 are particles (polymer or colloid) formed of black pigments such as aniline black and carbon black, and, for example, are positively charged. The white particles 53 are particles (polymer or colloid) formed of white pigments such as titanium dioxide, zinc flower, and antimony trioxide and, for example, are negatively charged.

In this instance, when the black particles 52 move from a wall surface of a bottom side which is opposite to the displaying surface side in the storage container 51 to displaying surface side, or moves from the displaying surface side to the bottom side, the black particles 52 have a property of being easily moved along a horizontal face which is a wall surface of the storage container 51 positioned at least between the displaying surface side and the bottom side, as compared with the white particles 53.

In addition, the display controller 100 includes, as shown in FIG. 3, an image signal processing unit 110 and a timing generator 120.

The image signal processing unit 110 generates a control signal of an image data and a control signal of an opposite electrode, and supplies the controls signals to the data line driving circuit 30 and the opposing electrode modulation circuit 40, respectively. The opposing electrode modulation circuit 40 supplies a bias signal and a voltage for the common electrode to the holding capacitor 90 of the pixel 11 and the common electrode 70, respectively.

In addition, when the display change preprocessing is set or the image data is output from the image signal processing unit 110, the timing generator 120 generates various timing signals to control the scanning line driving circuit 20 or the data line driving circuit 30.

In this embodiment, two kinds of predetermined voltage values are used as the voltage applied to the data line 13 and the common electrode line 14, that is, the voltage applied to the pixel electrode 60 and the common electrode 70. That is, any one of two kinds of voltage values is supplied to the data line 13 and the common electrode line 14 to control the gradation display of the respective pixels 11. Two kinds of voltage values are set to have a first potential Hi and a second potential Lo, in which the first potential Hi is a relatively high potential, while the second potential Lo is a relatively low potential.

The image signal processing unit 110 includes an image data reading portion 110A, an image conversion portion 110B, a display change preprocessing portion 110C, and an image writing portion 110D. When a new image is written, the process is carried out in order of the image data reading portion 110A, the image conversion portion 110B, the display change preprocessing portion 110C, and the image writing portion 110D.

As shown in FIG. 1, if a signal of an image writing request, such as an image selection or a next item sending, from an image selecting unit in input to a CPU, the CPU acquires the corresponding image data from a storage (HDD or auxiliary storage device such as flash memory), and then stores the image data in a cache memory. In addition, the CPU outputs the signal of image writing request to the image data reading portion 110A.

If the signal of the image writing request is detected, the image data reading portion 110A acquires the image data from the cache memory.

The image conversion portion 110B appropriately converts the image data acquired by the image data reading portion 110A to a size for display in accordance with a format of the image data, and then converts it to image data of black and white (gradation). Moreover, the image conversion portion 110B converts the black and white gradation image data to two-gradation image data. In this way, when a new display image, which is the display image for which a writing request has been made, is displayed, the gradation (the first gradation or the second gradation) of each pixel 11 is determined.

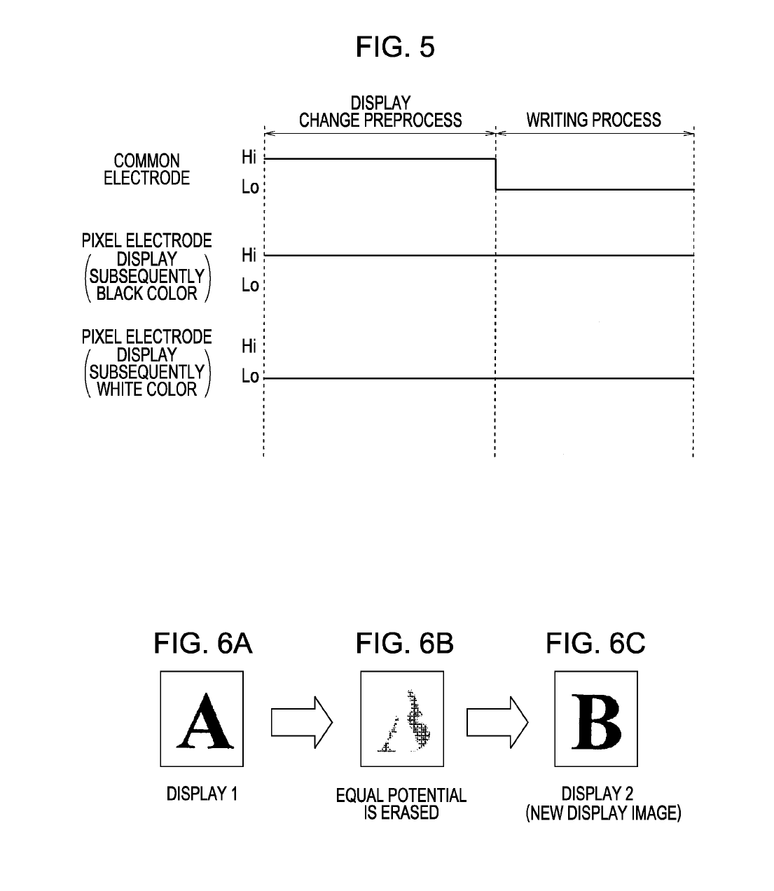

The display change preprocessing portion 110C is controlled to apply the first potential Hi to the common electrode 70 only for a predetermined reset period. In addition, the display change preprocessing portion 110C performs synchronous control to apply the first potential Hi to the pixel electrode 60 (first pixel electrode) of the pixel 11 (first pixel) displaying the black color, based on the two-gradation image data of black and white which is converted by the image conversion portion 110B, and applies the second potential Lo to the pixel electrode 60 (second pixel electrode) of the pixel 11 (second pixel) displaying the white. In this instance, the display change preprocessing portion 110C does not control the application at the equal potential in a pulse shape (refer to FIG. 5).

The reset operation by the drive control of the display change preprocessing portion 110C is as follows. That is, the opposing electrode modulation circuit 40 supplies the first potential Hi signal of high potential to the common electrode 70. In addition, the scanning line driving circuit 20 successively supplies a selection signal to the scanning line 12. The TFT 80 connected to the scanning line 12, which is supplied with the selection signal and thus is in the selection state, is turned on. At that time, the data signal Xi (reset signal) supplied from the data line driving circuit 30 in synchronization with the selection of the scanning line is written in each of the pixel electrodes 60. At that time, the holding capacitor 90 is charged at the voltage level of the data signal Xi. Thus, even after the TFT 80 is cut off, it holds the charge of the pixel 11 (the pixel electrode 60 and the common electrode 70) and the reset image by the electrophoretic particles 52 and 53.

As a result, in the pixel 11 displaying the black of the first gradation in the new display image, the pixel electrode 60 and the common electrode 70 are set to have the equal potential. In this way, even though the black particles 52 are attracted to the pixel electrode 60 side in the current display image, and are adhered along the wall surface of the pixel electrode 60 side of the storage container 51 in the electrophoretic element 50, the black particles 52 are floated by the setting to have the equal potential from the wall surface of the pixel electrode 60 side in the storage container 51, and thus are dispersed to some extent. For this reason, there is a case where a part of the pixels 11 which are next to become the black gradation may become a gray gradation. The gray indicates the gradation between the black and the white.

Meanwhile, in the pixel 11 displaying the white of the second gradation in the new display image, since the voltage relation between the pixel electrode 60 and the common electrode 70 is in the potential state for displaying the white color, the black particles 52 are attracted to the pixel electrode 60 side. As a result, the pixel 11 which is next to become the gradation of the white is first to display white.

In addition, the image writing portion 110D applies the second potential Lo to the common electrode 70 so as to display the new image. Further, the image writing portion 110D synchronously applies the first potential Hi to the pixel electrode 60 of the pixel 11 which displays the black of the first gradation, and applies the second potential Lo to the pixel electrode 60 of the pixel 11 which displays the white of the second gradation.

The operation of writing the image by the drive control of the image writing portion 110D is as follows. That is, the opposing electrode modulation circuit 40 supplies the second potential Lo signal of the low potential to the common electrode 70. In addition, the scanning line driving circuit 20 successively supplies the selection signal to the scanning line 12. The TFT 80 connected to the scanning line 12, which is supplied with the selection signal and thus is in the selection state, is turned on. At that time, the data signal Xi (image signal) supplied from the data line driving circuit 30 in synchronization with the selection of the scanning line is written in each of the pixel electrodes 60. At that time, the holding capacitor 90 is charged at the voltage level of the data signal Xi. Thus, even after the TFT 80 is cut off, it holds the charge of the pixel 11 (the pixel electrode 60 and the common electrode 70) and the reset image by the electrophoretic particles 52 and 53. Each of the pixels 11 displays the image in response to the voltage level of the data signal.

In this way, the black particles 52 are attracted to the common electrode 70 side by the potential difference between the pixel electrode 60 and the common electrode 70 in the pixel 11 displaying the black of the first gradation, and thus are collected along the wall surface of the common electrode 70 side (surface side) of the storage container 51 constituted of the microcapsule or the like in the electrophoretic element 50.

Further, in the pixel 11 displaying the white of the second gradation, the state where the white is displayed by the processing of the display change preprocessing portion 110C is retained.

Herein, this embodiment illustrates a case where the common electrode 70 is a transparent electrode, and the common electrode 70 side serves as the displaying surface side.

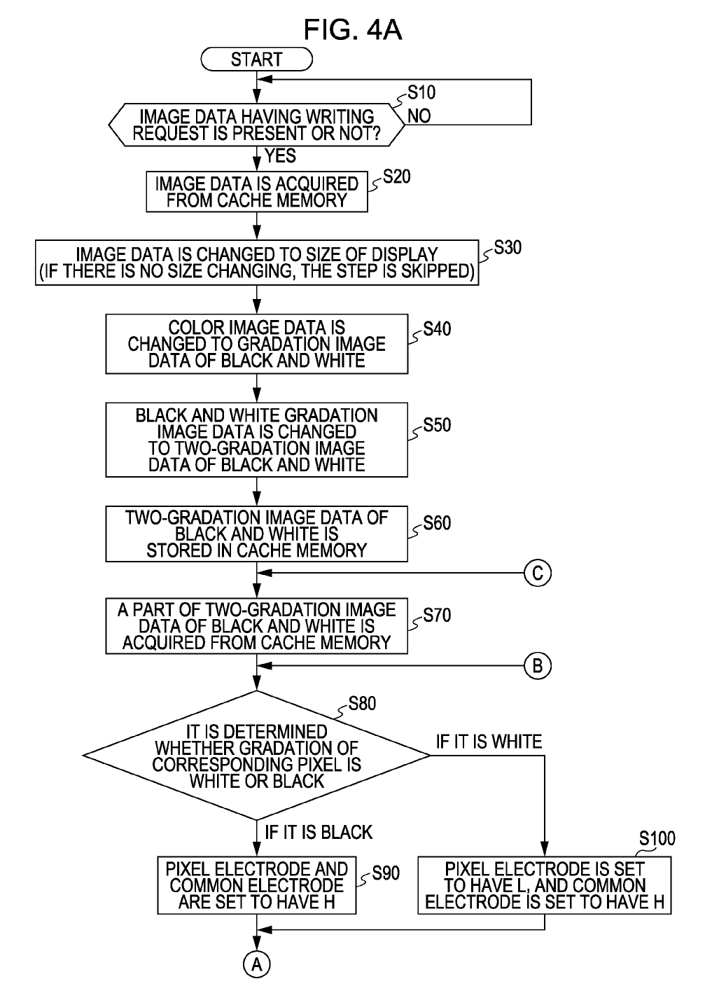

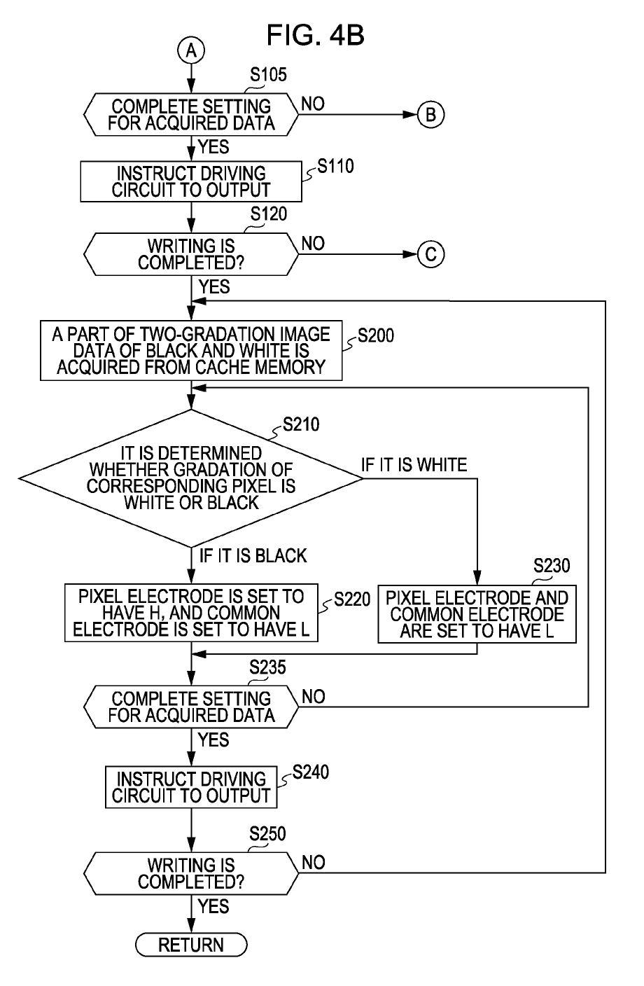

Next, the processing of the display controller 100 will be described with reference to FIGS. 4A and 4B which is a flowchart.

In step S10, the display controller 100 determines the presence or absence of the signal of image writing request. If the signal of image writing request is input, the process proceeds to step S20.

In step S20, the image data reading portion 110A acquires image data for rewriting next to the writing request from the cache memory.

Then, in step S30, the image conversion portion 110B converts the size of the image data. In addition, in step S40, in a case where the image data is color, the image conversion portion 110B converts the image data to the black and white gradation image data. Next, in step S50, the image conversion portion 110B converts the black and white gradation image data to the two-gradation image data of black and white. In step S60, the image conversion portion 110B stores the two-gradation image data of black and white in the cache memory.

Next, in step S70, the display change preprocessing portion 110C acquires a part of the two-gradation image data (information corresponding to one row) of black and white from the cache memory.

Then, in step S80, the display change preprocessing portion 110C determines whether the gradation of one of the pixels corresponding to a part of the acquired image data is the white or the black in the new display image which is subsequently rewritten according to the writing request, based on the two-gradation image data of black and white. If it is determined that it is the black color, the process proceeds to step S90. Meanwhile, if it is determined that it is the white color, the process proceeds to step S100.

In step S90, the display change preprocessing portion 110C sets the voltage of the pixel electrode 60 of the pixel 11, of which the gradation is determined in step S80, to have a voltage of the same potential as the common voltage. In this embodiment, the signal for setting the voltage of the pixel electrode 60 of the corresponding pixel 11 at the first potential Hi is output to the data line driving circuit 30. Herein, the common electrode 70 is set to have the first potential Hi.

In addition, in step S100, the display change preprocessing portion 110C outputs the signal for setting the voltage of the pixel electrode 60 of the corresponding pixel 11 at the second potential Lo to the data line driving circuit 30. Herein, the common electrode 70 is set to have the first potential Hi.

The display change preprocessing portion 110C repeats the processing in step S80 to step S100 with respect to each data signal of the pixels 11 corresponding to one row acquired in step S70 for each pixel (refer to step S105).

In step S110, in synchronization with the selection state (the TFT 80 connected to the scanning line 12 is turned on) in which the selection signal from the scanning line driving circuit 20 is supplied to the scanning line 12 of the row corresponding to the two-gradation image data acquired in step S70, based on the signal from the timing generator 120, the display change preprocessing portion 110C supplies a processing command to write to each pixel electrode 60 to the data line driving circuit 30. At that time, the opposing electrode modulation circuit 40 is supplied with the signal for setting the common electrode 70 at the first potential Hi.

Next, in step S120, it is determined whether the execution for each scanning line 12 corresponding to the image data which is subsequently rewritten is completed or not. If it is not completed, the target pixel row is changed, and the process proceeds to step S70. Meanwhile, if it is completed, the processing of the display change preprocessing portion 110C is regarded as completion, and the process proceeds to step S200.

Subsequently, in step S200, the image writing portion 110D acquires a part (information corresponding to one row) of the two-gradation image data of black and white from the cache memory.

Then, in step S210, the image writing portion 110D determines whether the gradation of one of the pixels corresponding to a part of the acquired image data is the white or the black in the new display image which is subsequently rewritten according to the writing request, based on the two-gradation image data of black and white. If it is determined that it is the black color, the process proceeds to step S220. Meanwhile, if it is determined that it is the white color, the process proceeds to step S230.

In step S220, the image writing portion 110D outputs the signal for setting the voltage of the pixel electrode 60 of the corresponding pixel 11 at the first potential Hi to the data line driving circuit 30. Herein, the common electrode 70 is set to have the second potential Lo.

In step S230, the image writing portion 110D outputs the signal for setting the voltage of the pixel electrode 60 of the corresponding pixel 11 at the second potential Lo to the data line driving circuit 30. Herein, the common electrode 70 is set to have the second potential Lo.

The image writing portion 110D repeats the processing in step S210 to step S230 with respect to each data signal of the pixels 11 corresponding to one row acquired in step S200 for each pixel (refer to step S235).

In step S240, in synchronization with the selection state (the TFT 80 connected to the scanning line 12 is turned on) in which the selection signal from the scanning line driving circuit 20 is supplied to the scanning line 12 of the row corresponding to the two-gradation image data acquired in step S70, based on the signal from the timing generator 120, the image writing portion 110D supplies a processing command to write to each pixel electrode 60 to the data line driving circuit 30. At that time, the opposing electrode modulation circuit 40 is supplied with the signal for setting the common electrode 70 at the second potential Lo.

Next, in step S250, it is determined whether the execution for each scanning line 12 corresponding to the image data which is subsequently rewritten is completed or not. If it is not completed, the target pixel row is changed, and the process proceeds to step S200. Meanwhile, if it is completed, the processing of the image writing portion 110D is regarded as completed, and it enters a standby mode.

### Operation and Function

FIG. 5 shows an example of a timing chart of the voltage applied to the common electrode 70 and the pixel electrode 60 by the above-described processing.

Next, the operation of the display image change will be described with reference to FIG. 5.

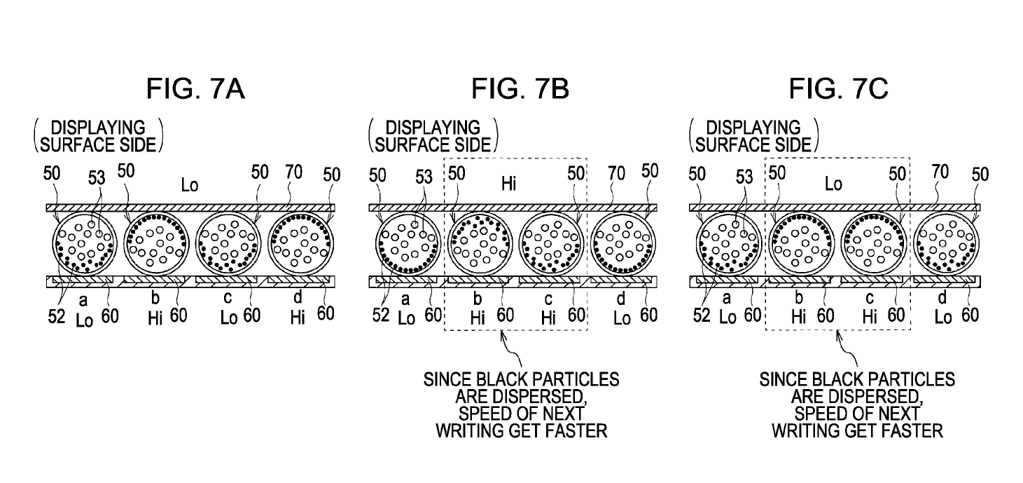

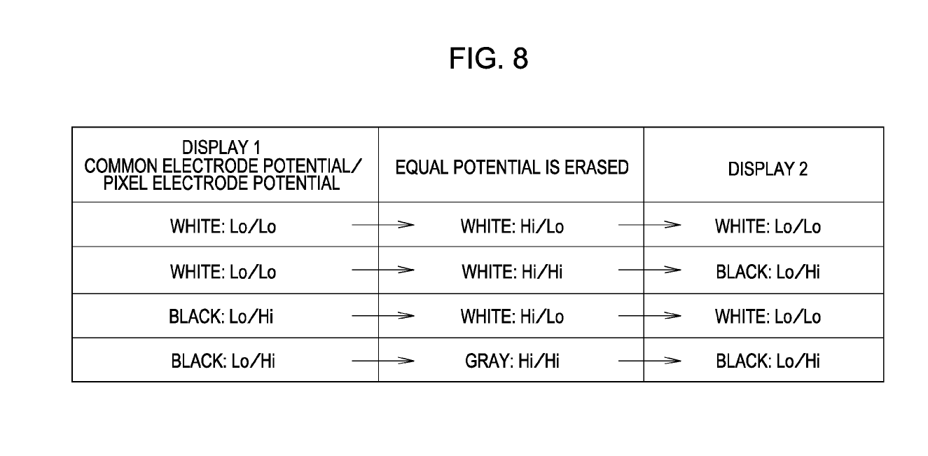

FIGS. 6A to 6C are conceptual views illustrating a changing state of the display image at the time of converting the display image. FIGS. 7A-C and FIG. 8 show the state of the voltage applied to the common electrode 70 and each pixel electrode 60. Herein, the electrophoretic particles 52 and 53 according to the embodiment have the positively charged white electrophoretic particles 52 and 53 and the negatively charged black electrophoretic particles 52 and 53.

FIG. 6A and FIG. 7A show a state where a black character “A” is displayed on a background of white as the current display image in the electrophoretic display unit 1 of the electrophoretic display device EPD. Herein, just before the character “A” is displayed, the portion displaying white is controlled to the state of displaying the white by the display change preprocessing portion 110C as the reset processing.

At the time of writing the character “A”, as shown in FIG. 7A and FIG. 8, the common electrode 70 is applied with the second potential Lo of the low potential. In addition, in the pixels b and d displaying the black color, the pixel electrode 60 is applied with the first potential Hi of the high potential, and in the pixels a and c displaying the white color, the pixel electrode 60 is applied with the second potential Lo of the low potential. Consequently, in the pixels b and d displaying the black color, the positively charged black electrophoretic particles 52 and 53 move to the common electrode 70 side serving as the displaying surface side, and thus are placed along the wall surface of the storage container 51 of the common electrode side, so that the black is displayed. Meanwhile, in the pixels a and c displaying the white color, the common electrode 70 and the pixel electrode 60 are set to have the equal potential, and thus the preprocessing state before the write is retained, so that the white is displayed. In this way, the character “A” of the current display is displayed on the electrophoretic display unit 1. After the character “A” is written, the pixel electrode 60 is set to have the same potential as the common electrode 70, for example, in accordance with a time constant of impedance between the common electrode 70 and the pixel electrode 60, so that the displaying content is retained. That is, it is in the standby state.

If the writing request of the new display image “B” is detected from the state, the image data reading, the image conversion processing, the display change preprocessing, and the writing processing of the new display image “B” are carried out in this order.

First, the image data reading portion 110A acquires the new image data to be subsequently displayed, and the image conversion portion 110B converts the acquired image data to the two-gradation image data.

Subsequently, the display change preprocessing portion 110C controls the common electrode 70 and the pixel electrode 60 to have the equal potential in the pixel 11 which becomes the gradation of black in the new display image, based on the two-gradation image data.

That is, the display change preprocessing portion of FIG. 5 applies the first potential Hi of high potential to the common electrode 70, as shown in FIG. 7B and FIG. 8. The display change preprocessing portion is controlled to apply the first potential Hi to the pixel electrode 60 of the pixel 11 which becomes the black in the new pixel display, and apply the second potential Lo of low potential to the pixel electrode 60 of the pixel 11 which becomes the white in the next image display.

In FIG. 7B, the pixels b and c are pixels which become the black in the next display. In addition, the pixels a and d are pixels which become the white in the next display.

In this way, the pixel electrode 60 and the common electrode 70 are set to have the equal potential in the pixel 11 which becomes the black color in the next image display. As a result, the black particles 52 adhered to the wall surface of the storage container 51 of the electrophoretic element 50 are spaced apart from the wall surface, and thus are floated. That is, the black particles 52 are spaced apart from the pixel electrode 60 and the common electrode 70. That is, the black particles 52 are dispersed in the dispersion medium inside the storage container 51.

In this way, as shown in FIG. 7B and FIG. 8, a part of the pixels 11 which become the black in the next display becomes the gray when seen from the displaying surface side. Herein, the term “gray” means an intermediate gradation between the black and the white.

In addition, in the pixel 11 which becomes the white in the new display image, since the pixel electrode 60 side is set to have the high potential relative to the common electrode 70, the black particles 52 move to the pixel electrode 60 side opposite to the displaying surface, thereby displaying the white color.

Then, the image writing portion 110D is controlled to apply the second potential Lo to the common electrode 70 as the voltage of the low potential. In addition, the image writing portion 110D performs control to apply the first potential Hi to the pixel electrode 60 of the pixel 11 which displays the black color, as the voltage of the high potential, and performs control to apply the second potential Lo to the pixel electrode 60 of the pixel 11 which displays the white color, as the voltage of the low potential, as in the writing process in FIG. 5.

In this way, as shown in FIG. 7C and FIG. 8, only in the pixel 11 which displays the black color, the positively charged black particles 52 move to the common electrode 70 side (surface side), thereby displaying the character “B”. In the pixel 11 displaying the black color, as the pixels b and c in FIG. 7C, since the black particles 52 are floated from the wall surface of the storage container 51 and thus are dispersed in the display change preprocessing portion 110C, as the pixels b and c in FIG. 7B, the movement of the black particles 52 to the common electrode 70 side is smoothly carried out. That is, the response of the writing of the next display image becomes fast. In this way, it is possible to display the good black.

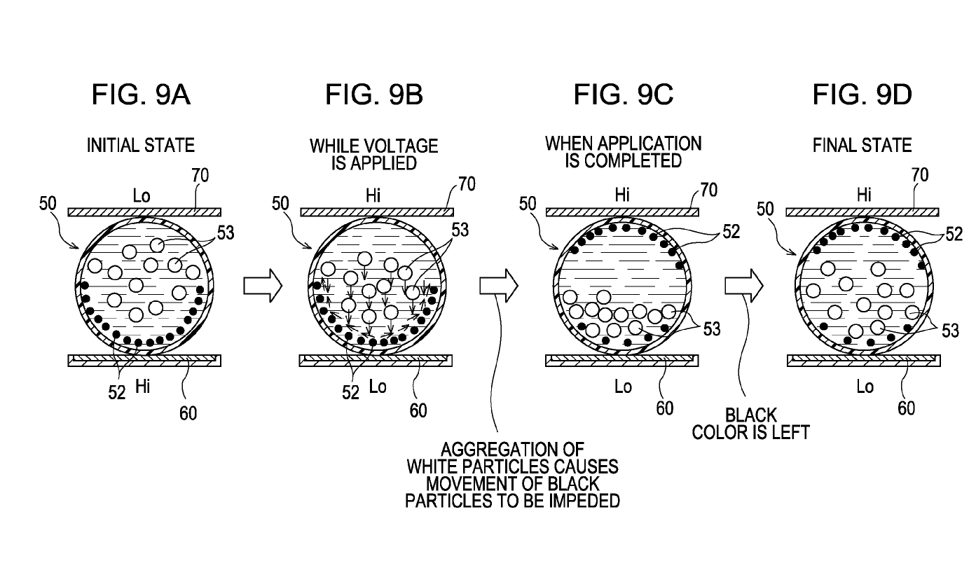

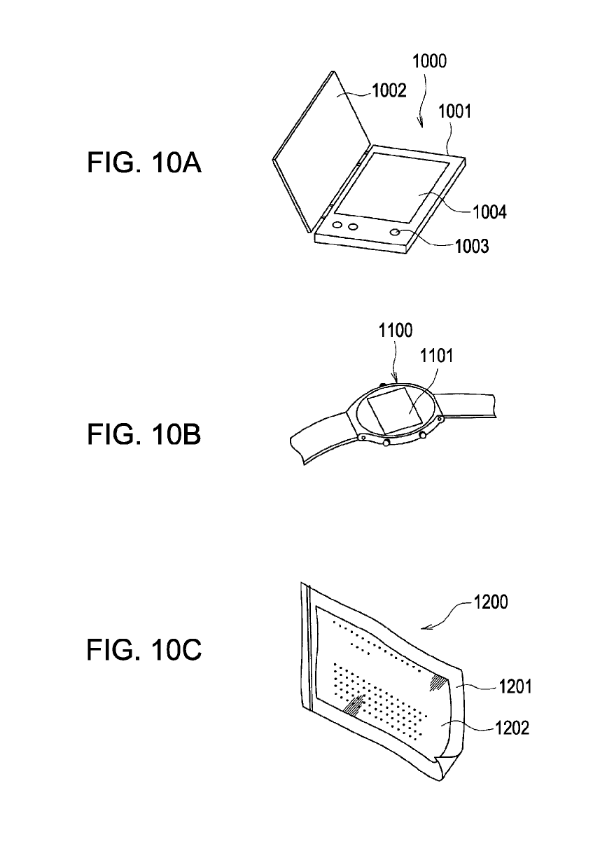

Herein, as a comparative example, after the entire pixels 11 is displayed in the white in the display change preprocessing portion 110C, if the writing process to display the black is carried out, one reason why the pixel 11 displaying the black displays the gray will be described with reference to FIGS. 9A to 9D.

First, FIG. 9A shows a state where the white is displayed in the display change preprocessing portion 110C, and the black particles 52 are attracted to the pixel electrode 60 side which is the bottom surface of the storage container 51. From this state, if the common electrode 70 is applied with the second potential Lo of the low potential and the pixel electrode 60 is applied with the first potential Hi of the high potential, as shown in FIGS. 9B and 9C, the aggregation of the white particles 53 by the movement of the white particles 53 to the pixel electrode 60 side causes the movement of part of the black particles 52 to be impeded. As a result, as shown in FIG. 9D, a part of the black particles 52 is not able to reach the common electrode 70 side of the displaying surface side, and is confined in the white particles 53, so that the part of the black particles is adhered to the pixel electrode 60 side.

In this regard, in this embodiment, when the display change preprocessing portion 110C of the reset processing applies the voltage to the pixel 11 which becomes the black in the next display, since the black particles 52 are spaced apart from the wall surface of the storage container 51 and thus are floated, it is possible to reduce the state where a part of the black particles 52 is confined in the white particles 53, and thus is adhered to the pixel electrode 60 side (the bottom side). As a result, it is possible to improve the contrast of the black/white display.

Herein, since the white is seen as white due to scattering of light which is caused by the white particles 53, it is preferable that the white particles 53 are dispersed to spread over the whole of the storage container 51. On the contrary, since the black absorbs the visible light, in the case of displaying the black color, it is preferable that the black particles are positioned to cover the wall surface of the displaying surface side.

### Electronic Apparatus

The electrophoretic display device EPD having the above-described configuration can be incorporated in various electronic apparatuses equipped with the electrophoretic display unit 1.

One example will be explained later.

FIGS. 9A to 9C are perspective views illustrating concrete examples of the electronic apparatus equipped with the electrophoretic display device EPD according to the invention. FIG. 9A is a perspective view illustrating an electronic book 1000 which is an example of the electronic apparatus. The electronic book 1000 includes a frame 1001 of a book shape, a cover 1002 pivotably (openable and closable) installed to the frame 1001, a manipulation unit 1003, and an electrophoretic display unit 1004 equipped with the electrophoretic display device EPD according to the invention.

FIG. 9B is a perspective view illustrating a wrist watch 1100 which is an example of the electronic apparatus. The wrist watch 1100 includes an electrophoretic display unit 1101 equipped with the electrophoretic display device EPD according to the invention.

FIG. 9C is a perspective view illustrating an electronic paper 1200 which is an example of the electronic apparatus. The electronic paper 1200 includes a body unit 1201 made of a rewritable sheet having a texture and flexibility like a paper, and an electrophoretic display unit 1202 equipped with the electrophoretic display device EPD according to the invention.

Since the electronic book, the electronic paper or the like, as described above, is presumably used to repeatedly write characters on the white background thereof, so that it is necessary to remove a residual image at the time of erasing or residual image over time.

Note that the electronic apparatus to which the electrophoretic display device EPD according to the invention is applicable is not limited to the above, but it widely includes apparatuses that use changes in ocular hue in accordance with the movement of electrically charged particles. The electrophoretic display device EPD according to the invention is applicable to a digital sign (advertisement) or the like.

### Effects of the Embodiment

(1) If the writing request of the new display image to be displayed on the electrophoretic display unit 1 is detected, before the voltage of the pixel electrode 60 for each pixel 11, and the common electrode 70 is controlled to have the voltage corresponding to the new display image, the display change preprocessing portion 110c controls the pixel electrodes 60 and the common electrode 70 for at least a part of the pixels 11 to have an equal potential.

That is, before the new display image is displayed, the display change preprocessing portion 110C controls the pixel electrodes 60 and the common electrode 70 for at least a part of the pixels 11 to have the equal potential. In this way, even though the black particles 52 are aggregated at the bottom side opposite to the displaying surface side in the current display image, the pixel 11 set to have the equal potential is in the state where the black particles 52 aggregated at the bottom side are spaced apart from the wall surface of the storage container 51, and thus are floated. In this way, the black particles 52 are dispersed to some extent. For this reason, when the voltage of the pixel electrode 60 and the common electrode 70 of the pixel 11 is set to have the voltage corresponding to the new display image, the movement until the electrophoretic particles 52 and 53 reach the displaying surface side in the pixel 11 displaying the black gradation can be fast. In this way, when the writing of the new display image is carried out, it is possible to obtain a good display, causing an improvement in contrast.

In this instance, since the equal potential is simply set only for the predetermined reset period, that is, the period of the display change preprocessing, as the processing of the display change preprocessing portion 110C, an increase in the power consumption is suppressed. In addition, since the electrophoretic particles 52 and 53 set to have the equal potential are simply dispersed to some extent, when the display is shifted from the current display image to the new displaying image, the screen blinking is not easily generated even though the gray is displayed as the intermediate color. It is possible to obtain a better display image at the time of converting the display image, and thus to reduce the stress on the eyes of the user.

(2) The display change preprocessing portion 110C controls the pixel electrode 60 of the pixel 11, which becomes the first gradation, and the common electrode 70 to have the equal potential in the new display image.

Therefore, even though the black particles 52 corresponding to the first gradation are aggregated at the bottom side of the storage container opposite to the displaying surface side of the electrophoretic element 50, the black particles 52 corresponding to the first gradation are spaced apart from the bottom surface of the electrophoretic element 50, and thus are dispersed. For this reason, when the voltage is applied to the pixel electrode 60 and the common electrode 70 of the pixel 11 so as to display the new display image, the movement until the electrophoretic particles 52 reach the displaying surface side can be fast. As a result, it is possible to more reliably display the first gradation aimed for.

(3) In addition, the display change preprocessing portion 110C controls the first pixel electrode 60 of the first pixel 11, which becomes the first gradation, and the common electrode 70 in the new display image to have the equal potential, and controls the second pixel electrode 60 of the second pixel 11, which becomes the second gradation different from the first gradation, and the common electrode 70 in the new display image to have a voltage corresponding to the gradation displayed on the new display image.

Before the writing processing of the new display image is carried out, the new display image is adjusted in such a way that the black particles 52 of the first pixel 11, which becomes the first gradation of black, are dispersed, and the electrophoretic particles 52 and 53 of the second pixel 11, which becomes the second gradation of white different from the first gradation, becomes white which is the gradation to be displayed on the new display image in advance. As a result, when the writing processing is carried out on the new display image, the pixel 11, which becomes the first gradation (black), in the new display image can become the first gradation more reliably, and the pixel 11 which becomes the other gradation (white) can become the target gradation (white) more reliably. Consequently, the contrast of the new display image is improved.

(4) Further, the display change preprocessing portion 110C sets the voltage of the pixel electrode 60 and the voltage of the common electrode 70 to any one of the voltage values of the predetermined first potential Hi and the predetermined second potential Lo to control the pixel electrode and the common electrode to have the equal potential.

That is, in order display the gradation, the voltage of the pixel electrode and the voltage of the common electrode are set to any one of two kinds of the predetermined voltage values to control the pixel electrode and the common electrode to have the equal potential. As a result, since the drive control is carried out by two-value control, the drive control including the display change preprocessing portion 110C is easily carried out.

(5) The electrophoretic display device EPD includes the above-described electrophoretic display unit 1, and the drive control device for the electrophoretic display unit 1.

In this way, it is possible to provide the electrophoretic display device EPD capable of carrying out good gradation display.

(6) The electronic apparatus includes the above-described electrophoretic display device EPD.

In this way, it is possible to provide the electronic apparatus capable of carrying out good gradation display.

### Modified Example

(1) The above-described embodiment illustrates the case where the first gradation is the black. The first gradation may be the white. In addition, the first gradation may be red, blue color, yellow or the like. Further, three or more electrophoretic particles may be stored in one electrophoretic element.

(2) The above-described embodiment illustrates the case where the black particles 52 are positively charged to display the first gradation, and the white particles 53 are negatively charged to display the second gradation.

In a case where the black particles 52 are negatively charged, and the white particles 53 are positively charged, it will be processed as follows.

That is, the display change preprocessing portion 110C applies the second potential Lo of the low potential to the common electrode 70. Then, the display change preprocessing portion 110C applies the second potential Lo to the pixel electrode 60 of the pixel 11 which subsequently displays the black color, and applies the first potential Hi of the high potential to the pixel electrode 60 of the pixel 11 which subsequently displays the white.

In addition, at the writing process, the first potential hi of the high potential is applied to the common electrode 70. Then, the second potential Lo is applied to the pixel electrode 60 of the pixel 11 which subsequently display the black color, and the first potential Hi of the high potential is applied to the pixel electrode 60 of the pixel 11 which subsequently displays the white color.

(3) Further, at the writing process of the display change preprocessing portion 110C, the voltage values of the pixel electrodes 60 of pixels 11 are the same. In view of this, only the voltage of the common electrode 70 may be changed at the writing process.

(4) The above-described embodiment illustrates the case where the display change preprocessing portion 110C sets the pixel electrode 60 and the common electrode 70 of the pixel 11 which displays the black in the new display image to have the equal potential. The equal potential may not be necessary. The display change preprocessing portion 110C may control the voltage of the common electrode 70 and the pixel electrode 60 so that the potential difference is smaller than the potential difference between the first potential Hi and the second potential Lo.

That is, the voltage to be applied during the period of the display change preprocessing can be set to have a potential difference smaller than that to be applied during the period of the writing process which can float the particles adhered to the wall surface of the storage container 51 from the corresponding wall surface, instead of the equal potential. For example, a potential difference is set to have about 1 to 2V.

In this way, the same effect as that of the above-described embodiment can be obtained. That is, a good display can be obtained when carrying out the writing process of the new display image, and thus the contrast can be improved.

(5) In addition, the above-described embodiment illustrates the case where the common electrode 70 side is the displaying surface. The pixel electrode 60 side may be the displaying surface.

### Second Embodiment

Next, the second embodiment will be described with reference to the drawings. In this instance, the same components as those of the first embodiment will be designated by like reference numerals for their description.

In the first embodiment, the driving voltage is controlled by two values of the first potential Hi and the second potential Lo. In contrast, this embodiment illustrates a case where, when the image writing portion 110D carries out the writing process of the new image which is subsequently rewritten corresponding to the writing request, the pixel electrode 60 is applied with any one of the first potential Hi and the second potential Lo, and the common potential is applied with an intermediate potential M. The intermediate potential M is set to have any potential between the first potential Hi and the second potential Lo. This embodiment illustrates a case where the intermediate potential M is set to a mean value M (=(Hi+Lo)/2) of the first potential Hi and the second potential Lo. Of course, it is not necessary to set the intermediate potential M to the mean value of the first potential Hi and the second potential Lo.

In this instance, the basic configuration of this embodiment is identical to the first embodiment.

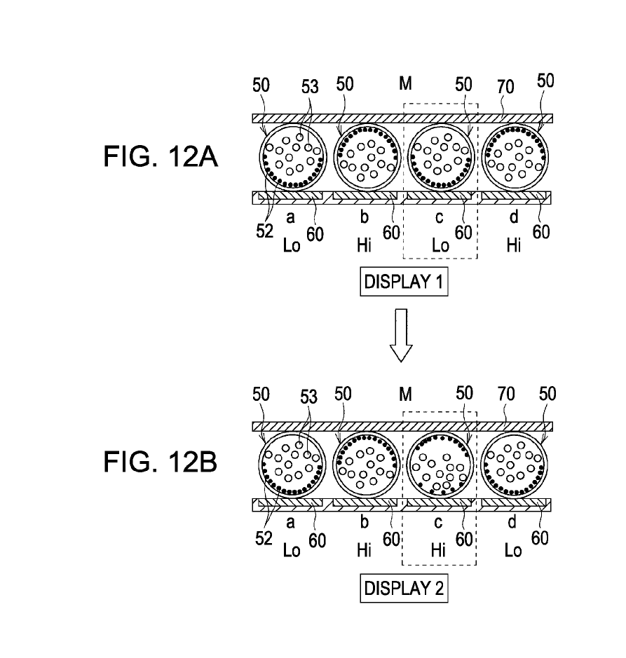

Herein, as this embodiment, in the case where the pixel electrode 60 is applied with any one of the first potential Hi and the second potential Lo, and the common potential is applied with the intermediate potential M, as shown in FIGS. 12A and 12B, as the pixel electrode 60 is applied with any one of the first potential Hi and the second potential Lo, the change of the gradation of the pixel which is shifted from the white display to the black display, and the pixel which is shifted from the black display to the white color display can be simultaneously carried out.

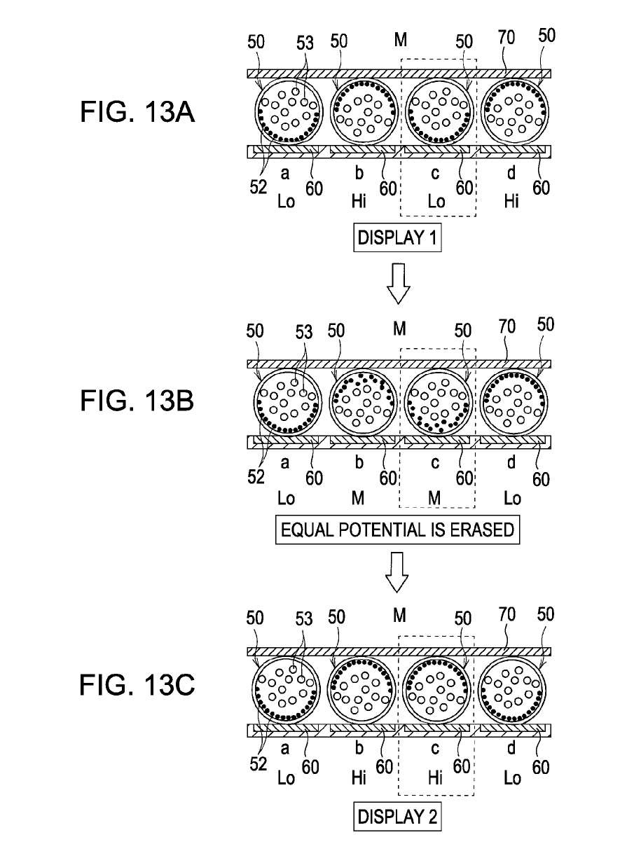

In contrast, in this embodiment, as shown in FIGS. 13A to 13C, when the writing process of the new display image (display 2) corresponding to the writing request is carried out from the current display image (display 1), the display change preprocessing is carried out before the new display image (display 2) is written, similar to the first embodiment.

In addition, as the display change preprocessing portion 110C applies the intermediate potential M to the pixel electrode 60 of the pixel 11 which displays the black in the new display image, the common electrode 70 and the pixel electrode 60 are controlled to have the equal potential before the display image is written. In this instance, the second potential Lo of the low potential is applied to the pixel electrode 60 of the pixel 11 which displays the white in the new display image, the black particles 52 are attracted to the pixel electrode 60 side of the bottom side.

In addition, at the writing process of the new display image, the first potential Hi is applied to the pixel electrode 60 of the pixel 11 displaying the black color, and the second potential Lo is applied to the pixel electrode 60 of the pixel 11 displaying the white. In this instance, the intermediate potential M is applied to the common electrode 70.

The rest of this embodiment is identical to the first embodiment.

### Operation

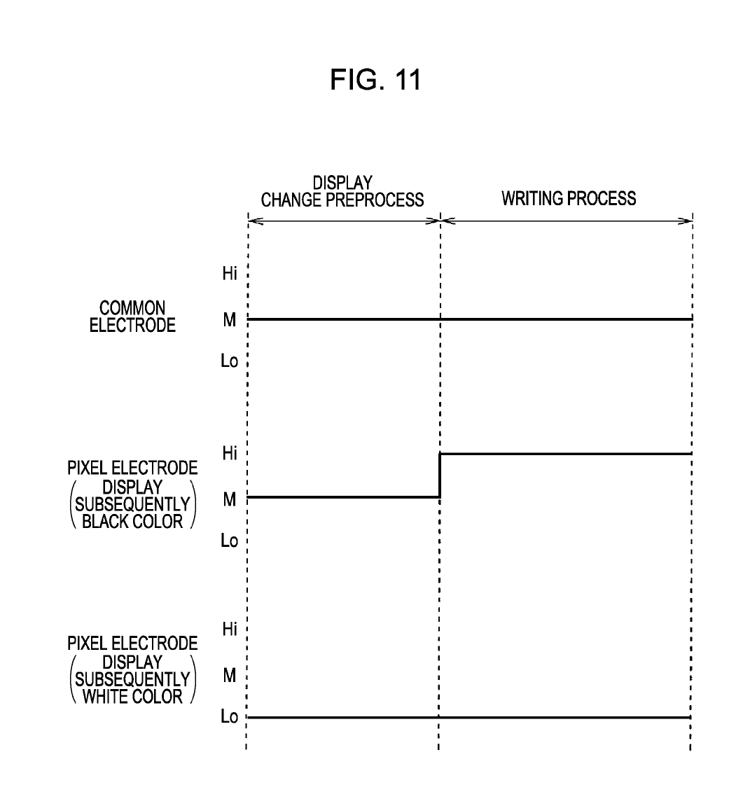

FIG. 11 illustrates an example of the timing chart of the common electrode and the pixel electrode according to this embodiment. The operation will now be described with reference to FIG. 11.

As shown in the pixel c of FIGS. 12A and 12B, if the current display is directly shifted to the black display with respect to the pixel 11 displaying the white color, as in FIG. 12A to FIG. 12B, the white particles and the black particles collide against each other, and thus the black particles 52 may exist on the pixel electrode 60 side. This may exert an adverse effect on the contrast when changing to the new display image.

In contrast, in this embodiment, as shown in FIG. 13B, the display change preprocessing portion 110C controls the pixel electrode 60 and the common electrode 70 to have the equal potential with respect to the pixel 11 subsequently displaying the black (portion of the display change preprocessing in FIG. 11). For this reason, the electrophoretic particles 52 and 53 in the electrophoretic element 50 are fluctuated, and thus the black particles 52 and the white particles 53 are likely to separate from each other.

In this state, the image writing portion 110D carries out the process of writing the new display image (portion of the writing process in FIG. 11). As shown in FIG. 13C, it is possible to reduce the number of black particles 52 which are left at the pixel electrode 60 side. That is, it is possible to obtain the good black display, and thus the contrast is improved.

The above description illustrates the case where the display change preprocessing portion 110C controls the pixel electrode 60 and the common electrode 70 to have the equal potential with respect to the pixel 11 which becomes the black in the new display image.

In contrast, the display change preprocessing portion 110C does not necessarily set the pixel electrode 60 and the common electrode 70 to have the equal potential with respect to the pixel 11 which currently displays the black and subsequently displays the black. If the display change preprocessing portion 110C sets the pixel electrode 60 to have the first potential Hi with respect to the pixel 11 which currently displays the black color and subsequently displays the black color, it becomes a gradation with higher black concentration. For this reason, it is necessarily noted such that a gradation difference with the black display does not occur in the pixel 11 which currently displays the white color and subsequently displays the black color.

### Effect of the Embodiment

(1) The drive control device for the electrophoretic display unit 1 is required in which the voltage of the pixel electrode 60 of each pixel 11 is set to any one of two kinds of predetermined voltage values, and the voltage of the common electrode 70 is set to have the intermediate potential which is the voltage value between two kinds of voltage values, thereby controlling each display of the pixels 11 with the gradation according to the image to be displayed. The display change preprocessing portion 110C sets the voltage of the pixel electrode 60 and the common electrode 70 to the intermediate potential to control the pixel electrode and the common electrode to have the equal potential.

Therefore, at the time of writing the new display image, the gradation display of the pixel 11 which is set to have the equal potential by the display change preprocessing portion 110C is improved.

The other effects of this embodiment is identical to those of the first embodiment.

### Modified Example

All above-described embodiments illustrate the case where only the pixel 11 which displays the black color in the new display image is set to have the equal potential at the processing of the display change preprocessing portion 110C. At the processing of the display change preprocessing portion 110C, the pixel 11 which displays the white color in the new display image may be set to have the equal potential. In the case of the first embodiment, however, since the white color is closer to the gray color when the white color is continuously displayed, it is preferable to appropriately generate the potential difference displaying the while between the common electrode 70 and the pixel electrode 60.

The entire disclosure of Japanese Patent Application No. 2010-023127, filed Feb. 4, 2010 is expressly incorporated by reference herein.

What is claimed is:

1. A drive control apparatus for an electrophoretic display unit performing drive control on the electrophoretic display unit which includes a plurality of pixels which are configured by placing electrophoretic elements storing electrophoretic particles between pixel electrodes and a common electrode opposite to the pixel electrodes, and which displays an image by determining a gradation to be displayed at each of the plurality of pixels in accordance with a voltage applied to the pixel electrodes and the common electrode, the drive control apparatus comprising:
a display change preprocessing portion that, if a writing request of the display image to be displayed on the electrophoretic display unit is detected, controls the pixel electrodes and the common electrode for at least a part of the plurality of pixels to have an equal potential before the voltage of the pixel electrode and the common electrode for each of the plurality of pixels, is controlled to have a voltage corresponding to the display image having a writing request.

2. The drive control apparatus according to claim 1, wherein the plurality of pixels have at least a first gradation as each display, and
the display change preprocessing portion controls the pixel electrode and the common electrode of the pixel, which becomes the first gradation, to have an equal potential in the display image having a writing request.

3. The drive control apparatus according to claim 1, wherein each of the plurality of pixels has at least a first gradation, and first electrophoretic particles for displaying the first gradation is negatively or positively charged; and
the display change preprocessing portion controls a first pixel electrode and the common electrode of a first pixel, which becomes the first gradation, in the display image having a writing request, among each of the plurality of pixels, to have an equal potential, and controls a second pixel electrode and the common electrode of a second pixel, which becomes a second gradation different from the first gradation, in the display image having a writing request, to have a voltage corresponding to the gradation displayed on the display image having a writing request.

4. The drive control apparatus according to claim 1, wherein the voltage of the pixel electrode and the common electrode in each of the plurality of pixels is respectively controlled to have any one of two kinds of the predetermined voltage values to control each display of the plurality of pixels with the gradation according to the image to be displayed; and
the display change preprocessing portion sets the voltage of the plurality of pixel electrodes and the voltage of the common electrode to any one of two kinds of the voltage values to control the pixel electrode and the common electrode to have the equal potential.

5. The drive control apparatus according to claim 1, wherein the voltage of the pixel electrode of each pixel is set to any one of two kinds of the predetermined voltage values, and the voltage of the common electrode is set to have an intermediate potential which is a voltage value between two kinds of the voltage values, thereby controlling each display of the plurality of pixels with the gradation according to the image to be displayed; and
the display change preprocessing portion sets the voltage of the pixel electrodes and the voltage of the common electrode to the intermediate potential to control the pixel electrode and the common electrode to have the equal potential.

6. An electrophoretic display device comprising the electrophoretic display unit according to claim 1, and a drive control device for the electrophoretic display unit.

7. An electrophoretic display device comprising the electrophoretic display unit according to claim 2, and a drive control device for the electrophoretic display unit.

8. An electrophoretic display device comprising the electrophoretic display unit according to claim 3, and a drive control device for the electrophoretic display unit.

9. An electrophoretic display device comprising the electrophoretic display unit according to claim 4, and a drive control device for the electrophoretic display unit.

10. An electrophoretic display device comprising the electrophoretic display unit according to claim 5, and a drive control device for the electrophoretic display unit.

11. An electronic apparatus comprising the electrophoretic display device according to claim 6.

12. An electronic apparatus comprising the electrophoretic display device according to claim 7.

13. An electronic apparatus comprising the electrophoretic display device according to claim 8.

14. An electronic apparatus comprising the electrophoretic display device according to claim 9.

15. An electronic apparatus comprising the electrophoretic display device according to claim 10.

16. A drive control method for an electrophoretic display unit which includes a plurality of pixels configured by placing electrophoretic elements having a storage container storing first electrophoretic particles corresponding to at least a first gradation and including charged particles, between pixel electrodes and a common electrode opposite to the pixel electrodes, and which displays an image by determining each gradation of the plurality of pixels in accordance with a voltage applied to the pixel electrodes and the common electrode,
wherein if a writing request of the display image to be displayed on the electrophoretic display unit is detected, before the voltage of plurality of the pixel electrodes and the common electrode for the plurality of pixels, is controlled to have a voltage corresponding to the display image having a writing request, in each of the plurality of pixels, a potential difference between the common electrode and the pixel electrodes which become the first gradation in the display image having a writing request is set to a potential difference, which can float the first electrophoretic particles including the charged particles away from a wall surface of the storage container of the electrophoretic element, during a predetermined reset period.
